(19) United States
(12) Patent Application Publication
(10) Pub. No.: US 2026/0260132 A1
(43) Pub. Date: Sep. 3, 2026

(54) Selective Information Exclusion in Artificial Intelligence Systems

(71) Applicant: Oracle International Corporation, Redwood Shores, CA (US)

(72) Inventors: Amir Hossein Rezaeian, San Mateo, CA (US); Sandip Ghoshal, Dublin, CA (US); Weiyi Sun, Somerville, MA (US); Vijayalakshmi Krishnamurthy, Sunnyvale, CA (US)

(73) Assignee: Oracle International Corporation, Redwood Shores, CA (US)

(21) Appl. No.: 19/066,463

(22) Filed: Feb. 28, 2025

(51) Int. Cl. G06N 5/02

(52) U.S. Cl. CPC G06N 5/02

(57) ABSTRACT

Methods, systems, and apparatus, including computer programs encoded on computer storage media, for selectively excluding information from responses generated by a response generation system are disclosed. In one or more implementations, a system obtains documents encompassing information to be excluded, analyzes this information to identify concepts for exclusion, and generates metadata characterizing these concepts. When processing a query, the system obtains a first response from the response generation system, then analyzes this response using the metadata to identify content that should be excluded. A second response is generated that excludes the identified content. The system evaluates the second response using a language model to determine a score based on the presence of excluded concepts characterized by the metadata. The second response is transmitted if the score meets a specified criterion, ensuring effective exclusion of unwanted information.

### TECHNICAL FIELD

This disclosure relates generally to generative Artificial Intelligence (AI) systems. More particularly, this disclosure relates to generative language model-based AI systems.

### BACKGROUND

Language Models (LMs) and Retrieval-Augmented Generation (RAG) systems have become integral components of modern AI applications. These systems process and store vast amounts of information that influences their responses and behaviors. However, significant challenges arise when specific information needs to be excluded from these systems after deployment.

In RAG systems, knowledge bases, once populated, are typically treated as static repositories. When information becomes outdated, expires, or is discovered to be inappropriate, removing or updating this information presents substantial technical difficulties. Simple deletion operations can be impractical or potentially harmful due to complex correlations and entanglements between documents within the knowledge base. These interconnections mean that removing one piece of information could create inconsistencies, gaps, or contradictions that degrade system performance.

Similar challenges exist with trained LMs. Once an LM has been trained on a dataset, the information from that training data becomes embedded within the model's weights. If training data is later discovered to have licensing issues or is deemed inappropriate, excluding this information from the model's responses becomes problematic. Traditional approaches might require complete model retraining, which is computationally expensive and may not be feasible when the original training data or process is inaccessible.

Additional complications arise in environments where privacy and security restrictions prevent direct modifications to knowledge bases after their initial provisioning. Organizations may need to exclude or update specific information while maintaining system integrity yet lack direct access to modify the underlying data structures or model weights.

The scale of modern AI systems further compounds these challenges. Knowledge bases can encompass millions of documents, making it impractical to manually review and modify content. Additionally, the same information may exist in different formats or variations across multiple databases, complicating efforts to consistently exclude specific content.

These technical problems highlight the need for improved approaches to managing information in AI systems, particularly regarding the selective exclusion or updating of specific content after deployment. Current solutions often require resource-intensive retraining or rebuilding of knowledge bases, which may be impractical or impossible in many real-world applications.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a method for filtering responses generated by a response generation system using metadata that characterizes concepts to be excluded from the responses according to one or more embodiments;

FIG. 2 illustrates a system for maintaining query context, identifying patterns across multiple queries, and consolidating metadata based on identified patterns according to one or more embodiments;

FIG. 3 illustrates a system for selectively excluding target information from document responses while preserving related valid content through correlation analysis and metadata generation according to one or more embodiments;

FIG. 4 illustrates a system for generating and routing multiple conceptually similar query variations to retrieve and combine information from different knowledge base portions according to one or more embodiments;

FIG. 5 illustrates a method for iteratively generating query variations and responses until achieving an acceptable score or reaching an iteration limit according to one or more embodiments;

FIG. 6 illustrates a system for identifying and characterizing high-level concepts across multiple documents and generating metadata for concept-level exclusion of related content according to one or more embodiments;

FIG. 7 illustrates a system for analyzing query patterns across multiple organizational users and updating metadata to exclude sensitive information in subsequent query responses according to one or more embodiments;

FIG. 8 illustrates a system for modifying response generation by simultaneously incorporating update information and excluding specified concepts while maintaining content consistency according to one or more embodiments;

FIG. 9 illustrates a system for processing documents through multiple stages to generate metadata characterizing excluded concepts and maintaining them in a persistent data structure according to one or more embodiments;

FIG. 10 illustrates a system for generating responses using an LM that simultaneously performs concept verification and response generation in an integrated process according to one or more embodiments;

FIG. 11 illustrates an example transformer model architecture that may be used in the implementation of an LM according to one or embodiments; and

FIG. 12 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. SELECTIVE DATA EXCLUSION IN ARTIFICIAL INTELLIGENCE SYSTEMS
   2.1 QUERY CONTEXT AND METADATA CONSOLIDATION
   2.2 SELECTIVE EXCLUSION SYSTEM
   2.3 QUERY PROCESSING
   2.4 QUERY VARIATION
   2.5 DOCUMENT CONTENT ANALYSIS
   2.6 ORGANIZATION-LEVEL PATTERN ANALYSIS
   2.7 UPDATE AND EXCLUSION HANDLING
   2.8 MUTLTI-STAGE PROCESS FOR GENERATING METADATA
   2.9 INTEGRATED RESPONSE GENERATION AND VERIFICATION PROCESS
3. EXAMPLE EMBODIMENT
4. PRACTICAL APPLICATIONS; ADVANTAGES; IMPROVEMENTS
5. EXAMPLE LANGUAGE MODEL ARCHITECTURE
6. COMPUTER NETWORKS AND CLOUD NETWORKS
7. HARDWARE OVERVIEW
8. MISCELLANEOUS; EXTENSIONS

### 1. General Overview

One or more embodiments exclude information from responses, generated by a response generation system, based on metadata that characterizes the concepts to be excluded. Initially, a system obtains a set of documents. The documents include information to be excluded from responses generated by the response generation system. An analysis of the information identifies included concepts that are to be excluded from responses. The system generates metadata that characterizes the concepts that are to be excluded from responses. Subsequently, the system modifies responses generated by the response generation system, in view of the metadata, to exclude the concepts characterized by the metadata. A score for the modified response represents a presence of the concepts in the modified response. If the score meets a criterion, the system transmits the modified response, in response to the query.

One or more embodiments maintain system performance while excluding unwanted information. The metadata characterizes concepts rather than specific text, enabling conceptual-level exclusion of information. Language model evaluation ensures the modified responses appropriately exclude unwanted concepts while maintaining responsiveness to the original query.

One or more embodiments operate without requiring modification of the underlying response generation system. The response generation system continues normal operation while a separate process examines and modifies responses to exclude unwanted information. This enables selective exclusion of information even when direct modification of the response generation system is not possible or practical.

One or more embodiments described in this Specification and/or recited in the claims may not be included in the General Overview section.

### 2.0 Selective Data Exclusion in Artificial Intelligence Systems

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 6, titled “Computer Networks and Cloud Networks.” In one or more embodiments, one or more operations performed by a system illustrated in a figure may be modified, rearranged, or omitted. Accordingly, the particular sequence of operations illustrated in a figure should not be construed as limiting the scope of one or more embodiments.

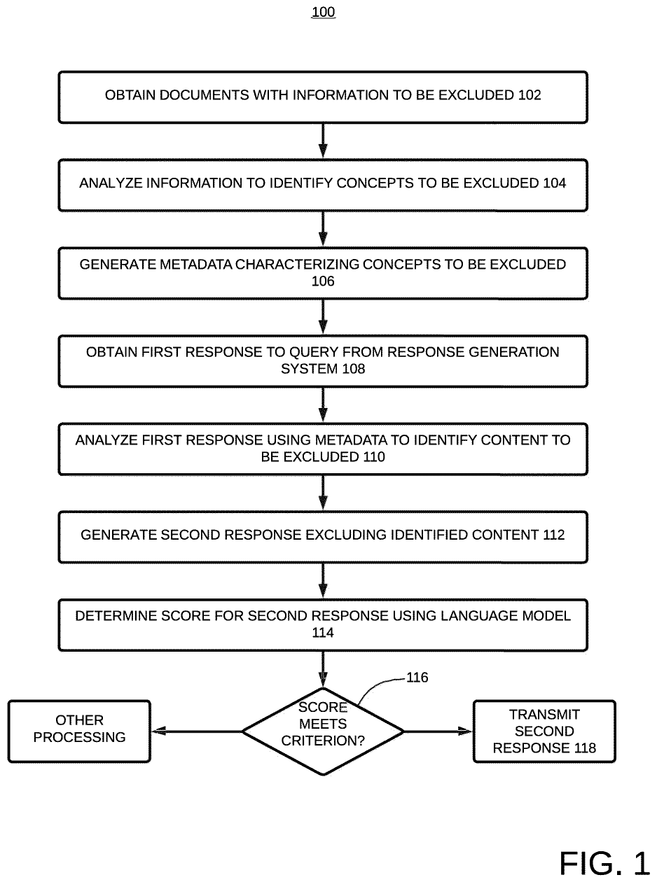

FIG. 1 illustrates a method 100 for filtering responses generated by a response generation system using metadata that characterizes concepts to be excluded from the responses according to one or more embodiments.

One or more embodiments analyze documents, including information that should be excluded from responses, and manage the generation of appropriate responses to queries. The method 100 first obtains a set of documents that includes information that should not appear in responses. The method 100 then analyzes these documents to identify specific concepts that need to be excluded.

One or more embodiments generate metadata that characterizes and describes the concepts marked for exclusion. When receiving a query, the method 100 obtains an initial response generated by a response generation system. The method 100 then analyzes this initial response using the previously generated metadata to identify any content that should be excluded.

One or more embodiments generate a second response by removing the identified excluded content from the initial response. The method 100 evaluates this second response using an LM to determine a score based on whether the second response includes any of the excluded concepts characterized in the metadata. The method 100 then transmits the second response if the second response's score meets specified criteria.

This approach provides a systematic way to filter generated responses and ensure the generated responses do not include prohibited information. The scoring mechanism adds an additional layer of verification to confirm the effectiveness of the content exclusion process. The use of metadata and LMs allows for sophisticated concept-level filtering rather than simple keyword matching.

In one or more embodiments, the method 100 obtains documents including information that needs to be excluded from future query responses (Operation 102). This document collection process serves as the initial step for implementing selective forgetting in the response generation system. The method 100 receives these documents through various means, such as direct uploads to a file server or through an organizational interface. These documents may include outdated, sensitive, or inappropriate information that should no longer appear in system responses.

The obtained documents can include a wide range of content types that require exclusion for different reasons-from outdated technical information to sensitive personal data. The method 100 processes these documents as “forget me” content, where each document serves as input for the metadata generation process that will eventually enable the selective exclusion of specific information from future responses. This document collection step is useful, for the document collection step establishes the foundation for what information the system needs to identify and exclude when generating responses to user queries.

The method 100 handles these documents with consideration for their relationships and dependencies with other information in the knowledge base. Rather than implementing immediate deletion, the method 100 first processes these documents to understand their content and context, preparing the documents for the subsequent analysis and metadata generation steps. This approach allows the method 100 to maintain system integrity while implementing forgetting operations, particularly when dealing with documents that have complex correlations with other content in the knowledge base.

The document collection process supports both individual document exclusion and concept-level exclusion, where multiple documents sharing common concepts can be grouped together for more efficient processing. This flexibility enables the method 100 to handle both specific content removal and broader concept-based exclusion requirements.

One or more embodiments analyze information to identify concepts to be excluded (Operation 104) as part of an approach to selectively removing unwanted information from response generation systems. A metadata generator identifies concepts within content marked for exclusion, moving beyond simple text matching to understand the underlying ideas and topics that should be forgotten. The analysis operates at a conceptual level; for example, if 100 pages of content marked for exclusion share a common concept despite being otherwise unrelated, the method 100 identifies and targets that specific concept for exclusion rather than trying to match exact text chunks. The method 100 analyzes chunks of content marked for exclusion across multiple databases to create topics, summaries, and other metadata about the content to be forgotten. This helps resolve conflicts, overlaps, and correlations between different chunks of content marked for exclusion. The analysis focuses specifically on identifying relevant concepts within the exclusion knowledge base itself rather than conflicts between the exclusion knowledge base and the valid knowledge base. By operating at a conceptual level, the method 100 can more effectively exclude related information even when related information appears in different forms or variations across the knowledge base. This conceptual analysis forms the foundation for generating metadata that will guide the method 100 in excluding unwanted information from future responses.

One or more embodiments generate metadata that characterizes concepts to be excluded from responses by analyzing documents marked for exclusion. The metadata generation process (Operation 106) involves analysis of the content to identify concepts, topics, and relationships within the information that needs to be excluded.

The metadata generator analyzes chunks of content across multiple databases to create metadata about the content to be forgotten. Rather than just identifying specific text chunks, the generator identifies higher-level concepts within the forget-me content. This allows the method 100 to remove content related to particular concepts that should be forgotten even when those concepts appear in different forms or variations throughout the knowledge base.

The generator focuses specifically on analyzing conflicts and overlaps as well as identifying important topics within the forgetting knowledge base itself. The generator creates topics, summaries, and other metadata about the content to be forgotten, helping resolve conflicts between different chunks of forget-me content. For example, if 100 pages of forget-me content share a common concept despite being otherwise unrelated, the metadata generator can identify and characterize that specific concept for exclusion.

The generated metadata provides a foundation for the method 100 to evaluate responses and ensure proper exclusion of forbidden information. The metadata feeds into subsequent processing steps where responses are analyzed and filtered to exclude the characterized concepts while maintaining relevance and coherence in the final output. The metadata generation process is a step that enables the method 100 to implement concept-level forgetting rather than just simple text matching and removal.

One or more embodiments obtain a first response to a query from a response generation system (Operation 108). This step occurs after metadata has been generated to characterize concepts that should be excluded from responses. The response generation system initially processes the query normally, without applying any exclusion filters, to produce this first response. The first response serves as a baseline that will be analyzed and modified to ensure proper exclusion of unwanted information. The response generation system can be either a RAG system pulling from a knowledge base or an LM system generating responses directly. The initial response provides the raw content that subsequent steps will filter and modify to create a properly filtered second response that excludes the identified concepts. By obtaining this unfiltered first response, the method 100 can then apply the metadata filters to identify and remove any content that matches the concepts marked for exclusion.

One or more embodiments analyze a first response using metadata to identify content that should be excluded (Operation 110). The analysis compares the first response against metadata that characterizes concepts identified in documents marked for exclusion. This metadata includes high-level descriptions, topics, summaries, and other digest information about content that should be forgotten or excluded from responses. A generation agent processes the first response and filters out any content that matches or relates to the concepts characterized in the metadata. The generation agent maintains the coherence and logical flow of the response while removing the excluded content. The analysis leverages the metadata compiled by the metadata generator agent and a metadata compiler agent, which have previously analyzed the documents marked for exclusion to identify key concepts, resolve conflicts and correlations, and create structured metadata about what should be excluded. The metadata-based analysis allows for concept-level filtering rather than just matching specific text chunks, enabling more comprehensive exclusion of related content. The analysis focuses on identifying any content in the first response that relates to concepts characterized in the metadata, so this content can be removed when generating a second response that properly excludes the forbidden information.

One or more embodiments generate a second response (Operation 112) that excludes identified content from a first response based on metadata characterizing concepts to be excluded. The generation agent processes the first response and filters out any content that matches concepts identified in the metadata as needing to be excluded. The generation agent maintains coherence and logical flow while removing the excluded content to create the second response. The generation agent uses LM prompting with specific instructions to exclude the forbidden information characterized in the metadata while still producing a relevant response to the original query. The metadata, provided in JSON format, helps guide the generation agent in identifying and removing content related to concepts that should be excluded. By analyzing the first response against the metadata and removing matching content, the generation agent produces a second response that preserves the core query-relevant information while ensuring sensitive, outdated, or otherwise unwanted concepts are excluded. This second response represents a “forgotten” version of the first response, with targeted content carefully filtered out based on the conceptual-level exclusion criteria defined in the metadata.

One or more embodiments determine a score for a second response using an LM to evaluate how effectively the response excludes specified concepts (Operation 114). The LM analyzes the second response to calculate a forgetting score that measures if concepts identified in the metadata as needing to be excluded are still present in the response. The scoring process comprises multiple metrics, including a retention score that quantifies how much forbidden information remains and a similarity score that measures vector similarity between the response and the information marked for exclusion. The LM processes these metrics to produce an overall score that indicates the effectiveness of the forgetting operation. This score helps determine if the second response meets the required exclusion criteria before being transmitted to users. If the score falls below an acceptance threshold, the method 100 triggers additional processing iterations to improve the exclusion of forbidden concepts. The LM's scoring capabilities ensure that responses maintain relevance to the original query while properly excluding specified concepts and information.

One or more embodiments evaluate a generated response using a scoring mechanism to ensure proper exclusion of unwanted information. Determining if a score meets a criterion (Operation 116) represents a decision point in the workflow. The scoring mechanism employs an LM to analyze the generated response for any presence of concepts that were marked for exclusion in the metadata. The method 100 transmits responses that achieve scores meeting a predetermined acceptance threshold, ensuring effective information exclusion. When the score meets the criterion, the score indicates that the response has successfully excluded the targeted information while maintaining relevance to the original query. The scoring process specifically looks for concepts rather than just exact text matches, allowing for more comprehensive evaluation of whether sensitive or outdated information has been properly excluded. The scoring checkpoint helps maintain the integrity of the method 100's forgetting capabilities by preventing responses that might inadvertently include excluded concepts from reaching users. The scoring mechanism operates as part of a feedback loop, where responses that fail to meet the score criterion trigger additional processing until an acceptable response is generated or until the method 100 determines that proper exclusion cannot be reliably achieved.

One or more embodiments transmit a second response (Operation 118) to a user after determining that the response meets quality criteria for excluding unwanted information. The transmission occurs as a step in a process that comprises analyzing documents that includes information to be excluded, generating metadata about concepts to exclude, obtaining and analyzing an initial response, and generating a modified second response. The method 100 transmits the second response after confirming through a scoring process that the second response properly excludes the identified concepts that should be forgotten. The scoring process uses an LM to evaluate if any of the excluded concepts are still present in the response. The transmission represents the successful completion of the forgetting process, where the method 100 has verified that the response meets the required forgetting threshold and can be safely shared with the user. If the score had not met the criterion, the method 100 would have instead initiated additional processing rather than transmitting the response. The transmission step ensures that users receive responses that have been properly filtered to exclude sensitive or outdated information while maintaining relevance to their query.

### 2.1 Query Context and Metadata Consolidation

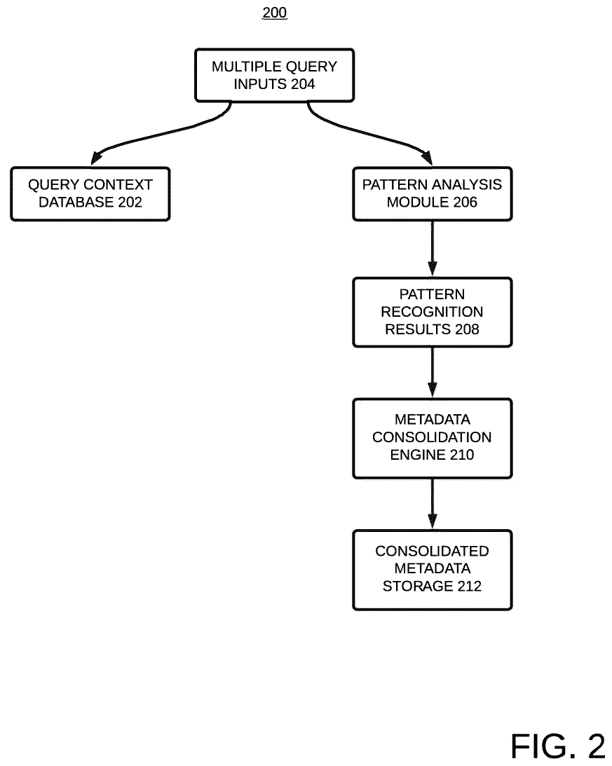

FIG. 2 illustrates a system 200 for maintaining query context, identifying patterns across multiple queries, and consolidating metadata based on identified patterns according to one or more embodiments. The system 200 represents an extension of the method 100 of FIG. 1. Unless the context clearly indicates otherwise, the system 200 may be used in conjunction with or independent of any of the other extensions of the method 100 of FIG. 1 disclosed herein with respect to the other figures.

One or more embodiments maintain context information across multiple queries in a conversation or session. The system 200 tracks and analyzes patterns that emerge from these multiple queries. For example, the system 200 may identify recurring themes, related subject matter, or progressive refinements in the queries. Based on the identified patterns, the system 200 consolidates the metadata that characterizes concepts to be excluded from responses. The consolidation helps create a more comprehensive and cohesive set of exclusion criteria that accounts for the relationships between queries in the conversation. The consolidated metadata enables more accurate and consistent filtering of excluded concepts across the entire conversation rather than treating each query in isolation. This pattern-based consolidation builds upon the base method 100 of FIG. 1 of generating and using metadata to exclude certain content from responses but extends the pattern-based consolidation to work more effectively across a series of related queries by leveraging the contextual relationships between them.

One or more embodiments maintain a query context database 202 that stores context information across multiple user queries to build understanding of query patterns and their relationships to excluded concepts. The query context database 202 identifies similarly themed queries requiring exclusion, recognizes patterns in user requests related to excluded concepts, and consolidates metadata about excluded concepts at a higher level. The query context database 202 enables handling of complex document correlations while consistently excluding sensitive or outdated information across user interactions.

One or more embodiments provide multiple query inputs 204 that enable pattern identification and relationship analysis across different queries related to similar concepts requiring exclusion. The system 200 processes these inputs to consolidate metadata about excluded concepts at a higher conceptual level, simplifying forgetting instructions by recognizing related topics. By analyzing multiple query inputs 204, the system 200 maintains consistent exclusion of sensitive information while preserving valid content, basing filtering decisions on the broader context of related queries rather than isolated queries.

One or more embodiments include a pattern analysis module 206 that analyzes context across multiple user queries to improve exclusion of unwanted information. The pattern analysis module 206 identifies recurring patterns between related queries and consolidates metadata about excluded concepts at an abstract level rather than maintaining separate entries for each instance. This consolidation reduces redundancy by recognizing similarly targeted concepts across differently expressed queries. By using higher-level conceptual representations instead of individual text chunks, the pattern analysis module 206 enables more efficient information exclusion while maintaining consistent behavior across organizational query patterns.

One or more embodiments include pattern recognition results 208 that analyze multiple queries to identify recurring patterns and relationships. The pattern recognition results 208 maintain context across queries by tracking related topics and concepts for exclusion. By analyzing patterns, the system 200 identifies high-level concepts shared across queries despite variations in text or format. The pattern recognition results 208 enable consolidation of forgetting instructions at a conceptual level rather than managing individual text chunks. When queries show similar patterns, the system 200 applies consolidated metadata to exclude concepts across related queries efficiently.

One or more embodiments implement a metadata consolidation engine 210 that analyzes patterns across multiple user queries to optimize concept exclusion from responses. The metadata consolidation engine 210 consolidates metadata describing similar concepts into more abstract representations rather than maintaining separate entries for each query. This consolidation streamlines exclusion processing by recognizing conceptual similarities between differently worded queries and ensures consistent handling while reducing metadata redundancy.

One or more embodiments implement a consolidated metadata storage 212 that maintains context and metadata across multiple queries. The consolidated metadata storage 212 stores metadata about concepts in excluded documents using a query-aware data structure with JSON-like formatting. The consolidated metadata storage 212 tracks relationships between queries and excluded concepts, consolidates metadata based on patterns across related queries, and maintains organization-wide consistency for excluding sensitive information.

### 2.2 Selective Exclusion System

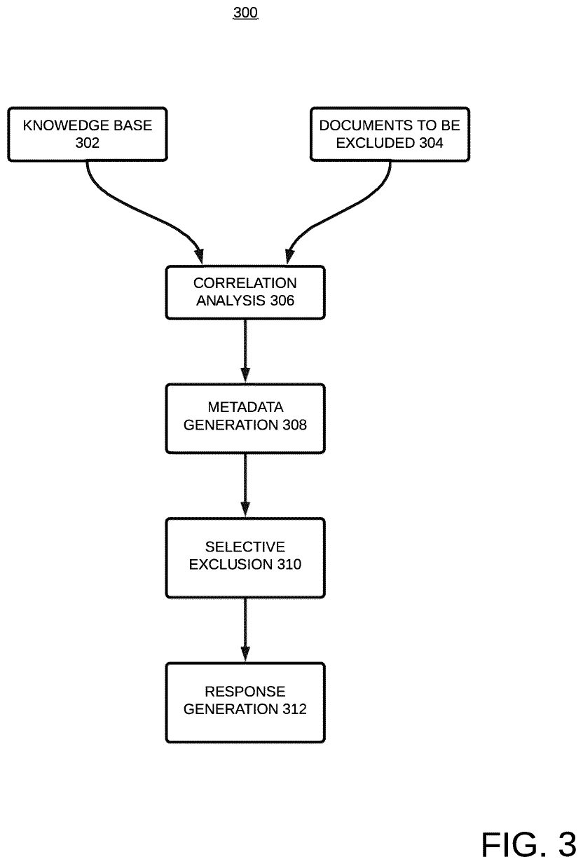

FIG. 3 illustrates a system 300 for selectively excluding target information from document responses while preserving related valid content through correlation analysis and metadata generation according to one or more embodiments. The system 300 represents an extension of the method 100 of FIG. 1. Unless the context clearly indicates otherwise, the system 300 may be used in conjunction with or independent of any of the other extensions of the method 100 of FIG. 1 disclosed herein with respect to the other figures.

One or more embodiments analyze information to be excluded by identifying relationships between documents marked for exclusion and documents within a knowledge base. The system 300 examines correlations between these document sets to understand their connections and similarities. Based on this analysis, the system 300 generates metadata that helps differentiate between content that should be excluded (target information) and legitimate content that should remain available for responses (related valid content). The metadata serves as a filtering mechanism during response generation. When creating the second response, the system 300 uses the metadata to precisely remove the target information while maintaining any related valid content. This selective exclusion process ensures that the system 300 removes inappropriate or unwanted content without accidentally removing legitimate, related information that should remain available for responses. The approach maintains the response generation system 300's ability to access and use valid content while implementing targeted exclusions of specific unwanted information.

One or more embodiments analyze documents in a knowledge base 302 to manage complex relationships between documents marked for exclusion and valid documents. The analysis identifies correlations and dependencies between documents to maintain knowledge base 302 integrity during selective forgetting operations. Instead of simple deletions, the embodiments generate metadata that specifies concepts for exclusion while preserving related valid content. During response generation, the metadata enables filtering of target information while maintaining contextual relationships and valid content in the knowledge base 302.

One or more embodiments analyze documents marked for exclusion 304 by examining their relationships and dependencies with other knowledge base content. The analysis generates precise metadata that distinguishes sensitive and public information within documents rather than excluding entire documents. When generating responses, the system 300 uses the metadata to selectively suppress the targeted sensitive information while preserving related valid content, maintaining knowledge base integrity and coherent responses despite complex document relationships.

One or more embodiments implement a correlation analysis component 306 that examines relationships between excluded and valid documents in the knowledge base 302. The analysis identifies document interlinking and generates metadata to precisely define which information to exclude while preserving valid content integrity. For example, when a document includes both sensitive and valid reference data, the metadata enables selective suppression of sensitive portions. This allows the generation agent to maintain coherent responses while appropriately excluding target information and retaining important context from valid documents.

One or more embodiments implement a metadata generation component 308 that analyzes document relationships and correlations to enable selective content exclusion. The metadata generation component 308 analyzes excluded documents and their relationships with knowledge base documents, identifying interlinking between excluded document and knowledge based documents, and determining specific content for exclusion while preserving valid information. The metadata generation component 308 creates metadata to distinguish exclusion targets from valid content, preventing knowledge base corruption during deletion of interlinked information. When generating responses, this metadata enables suppression of target information while maintaining related valid content integrity. For example, when a sensitive document correlates with valid documents through common topics, the metadata allows exclusion of just the sensitive portions while preserving valuable related content.

One or more embodiments implement a selective exclusion component 310 that handles document correlations and dependencies when excluding information from system responses. The component 310 analyzes relationships between excluded documents and knowledge base documents to maintain consistency. The selective exclusion component 310 generates metadata to precisely identify content for exclusion while preserving valid related content. During response generation, the selective exclusion component 310 uses this metadata to selectively remove target information while maintaining coherence of valid content, preventing knowledge base corruption from naive removal of interlinked information.

One or more embodiments implement a response generation component 312 that selectively excludes target information while preserving related valid content. The response generation component 312 processes correlations between excluded documents and main knowledge base documents using metadata analysis rather than simple deletion. The response generation component 312 receives prompts specifying which metadata-identified content to exclude and generates responses that omit forbidden information while maintaining query relevance and knowledge base integrity, particularly for interlinked information.

### 2.3 Query Processing

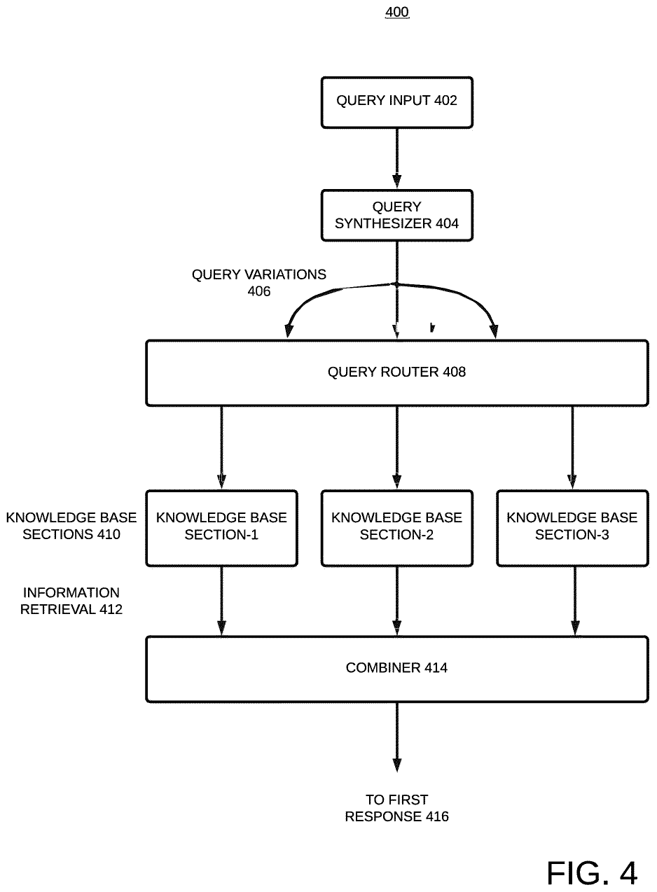

FIG. 4 illustrates a system 400 for generating and routing multiple conceptually similar query variations to retrieve and combine information from different knowledge base portions according to one or more embodiments. The system 400 represents an extension of the method 100 of FIG. 1. Unless the context clearly indicates otherwise, the system 400 may be used in conjunction with or independent of any of the other extensions of the method 100 of FIG. 1 disclosed herein with respect to the other figures.

One or more embodiments expand the query processing by generating multiple variations of the original query while preserving the query's conceptual meaning. These variations help explore several aspects of the query while maintaining the query's core intent. The system 400 routes each variation to different sections of a knowledge base, allowing for a broader search across diverse information sources. After retrieving relevant information for each query variation, the system 400 combines this collected information. This combined information serves as input for generating the initial response, which then undergoes the exclusion analysis and refinement process as described above with respect to the method 100 of FIG. 1. The generation of query variations and collection of diverse information helps create a more comprehensive initial response before applying the content exclusion rules. This approach ensures that the final response complies with the exclusion requirements and benefits from a broader information gathering process that considers multiple perspectives of the original query.

One or more embodiments include a query input 402 that accepts an original user query and initiates multi-stage query processing. The query input 402 works with a query synthesizer agent to generate multiple, semantically different variations of the query while preserving the query's core meaning. These variations enable searching different knowledge base sections to retrieve and combine relevant information before generating an initial response.

One or more embodiments implement a query synthesizer 404 that creates multiple, semantically different but conceptually similar versions of an incoming user query while preserving the original query's core meaning and intent. The query synthesizer 404 uses language model-based prompting techniques and maintains access to metadata about data sources and excluded datasets. Working with a routing system, the query synthesizer 404 directs the synthesized queries to different knowledge base segments, enabling comprehensive information retrieval. After retrieving information for each query variation, the system 400 combines the results before generating an initial response. This approach helps ensure thorough coverage while properly excluding specified unwanted information.

One or more embodiments generate multiple query variations 406 while preserving the core meaning of an original query to better exclude unwanted information from responses. The query synthesizer creates these variations using LM prompting, representing different semantic expressions of the same query intent. The system 400 routes these variations to different knowledge base segments, retrieves and combines relevant information, and uses the query variations alongside metadata about excluded concepts to thoroughly filter unwanted content. This process continues until achieving acceptable forgetting scores or reaching iteration limits.

One or more embodiments implement a query router 408 that directs multiple query variations to different knowledge base portions. The query router 408 receives conceptually similar variations of an original user query and analyzes each variation to determine the variation's appropriate knowledge base destination. Using the query router 408's instruction set and an LM, the query router 408 makes routing decisions that distribute the retrieval workload across knowledge base partitions. This routing enables comprehensive information gathering by directing similar queries to different segments, allowing collection of diverse perspectives about the same concept. The query router 408 coordinates with downstream components that process the retrieved information and generate a final response excluding unwanted concepts identified in metadata.

One or more embodiments divide a knowledge base into sections 410 to enable efficient targeted information retrieval when processing query variations. The sections 410 represent distinct portions of the knowledge repository that can be independently accessed. Different variations of an original query, while maintaining the original query's core meaning, route to separate knowledge base sections 410. For example, a query about renewable energy may generate variations like “solar power generation methods,” “wind energy technologies,” and “renewable power sources,” directing each to specialized sections 410. The system retrieves and combines relevant information from accessed sections before generating an initial response. This sectioned approach enables comprehensive information gathering while implementing selective content exclusion and allows parallel processing of query variations.

One or more embodiments employ information retrieval 412 encompassing parallel data flow when processing multiple query variations across different knowledge base portions. The information retrieval 412 represents how the system simultaneously retrieves information from multiple knowledge base segments while maintaining conceptual similarity to the original query. This parallel retrieval approach enables comprehensive information gathering from sharded datasets before consolidating results into a first response.

One or more embodiments implement a combiner 414 that aggregates and consolidates information retrieved from different knowledge base portions in response to multiple query variations. The combiner 414 removes duplicates while preserving unique content, resolves conflicts between information chunks, and maintains conceptual alignment with the original query. The consolidated information serves as input for generating the first response, ensuring comprehensive yet efficient information gathering across the knowledge base.

One or more embodiments include a first response 416 that represents combined information retrieved from multiple query variations routes to generate a first unfiltered response before any content exclusion or filtering occurs. The first response 416 represents how consolidated query results from different knowledge base portions converge into the initial response generation phase.

### 2.4 Query Variation

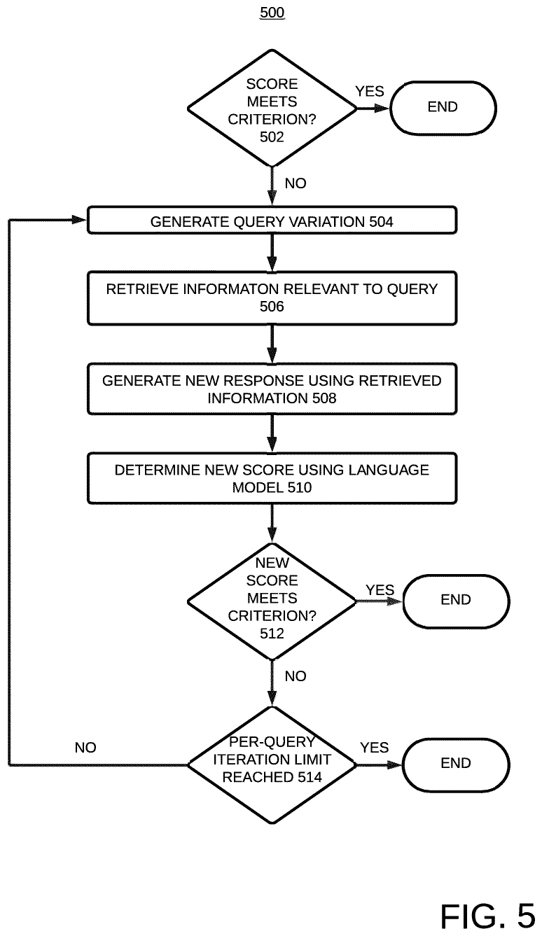

FIG. 5 illustrates a method 500 for iteratively generating query variations and responses until achieving an acceptable score or reaching an iteration limit according to one or more embodiments. The method 500 represents an extension of the method 100 of FIG. 1. Unless the context clearly indicates otherwise, the method 500 may be used in conjunction with or independent of any of other extensions of the method 100 of FIG. 1 disclosed herein with respect to the other figures.

One or more embodiments initiate an iterative refinement process when an initial filtered response does not meet a scoring criterion. The iterative refinement process creates variations of the original query to find an acceptable response. For each iteration, the method 500 generates a modified version of the query and retrieves relevant information based on this variation. The method 500 then generates a new response using the retrieved information. An LM evaluates the new response by checking for the presence of excluded concepts characterized by the previously generated metadata. The method 500 calculates a new score based on this evaluation. The iterative process continues until one of two conditions is met; either the new response achieves a score that satisfies the criterion, or the method 500 reaches a predetermined limit on the number of iterations allowed for the query. This approach provides a systematic method to refine responses when initial attempts to exclude sensitive information result in responses that do not meet quality standards. The iteration limit ensures the iterative refinement process terminates even if no satisfactory response is found.

One or more embodiments implement a decision point (Operation 502) that evaluates if a calculated response score meets an acceptance threshold. If the score fails to meet the threshold, the method 500 initiates a feedback loop to generate query variations and new responses until achieving an acceptable score or reaching a maximum iteration limit. The method 500 calculates scores using an LM to evaluate how effectively responses exclude concepts marked for forgetting in the metadata. When responses fail the scoring criterion, the method 500 automatically attempts additional processing rather than sending potentially inappropriate responses to users.

One or more embodiments employ a query synthesizer agent to generate multiple variations of an original query when initial responses do not meet forgetting criteria (Operation 504). The query synthesizer agent creates semantically different but conceptually similar query variations using different techniques, such as noise injection, query similarity generation, and query generalization. Each query variation triggers new information retrieval and response generation. An LM evaluates if the new response properly excludes concepts identified in metadata, producing a forgetting score. The evaluation process continues until either a response meets the acceptance criterion for excluding unwanted concepts or reaches a predetermined iteration limit. The query variation process works with metadata about excluded concepts to systematically explore different approaches for obtaining relevant information while maintaining exclusion requirements, providing a robust selective forgetting mechanism without modifying the underlying knowledge base or model.

One or more embodiments retrieve relevant information as part of an iterative query-response process that excludes forbidden content (Operation 506). After generating a query variation due to a failed forgetting score, the method 500 retrieves information chunks from knowledge bases relevant to the varied query. A combiner agent aggregates these chunks, removes duplicates, and resolves conflicts between chunks from different queries. The method 500 maintains access to both valid and excluded content knowledge bases to gather comprehensive information while identifying content for exclusion. The retrieved information informs new response generation for forgetting criteria evaluation, continuing until reaching an acceptable response or the maximum iteration limit.

One or more embodiments generate new responses through an iterative loop when initial responses fail to meet forgetting score criteria (Operation 508). A generation agent processes retrieved information chunks while applying filters based on metadata, maintaining coherence while excluding forbidden content. The generation agent uses LM prompting with specific instructions to handle conflicts between retrieved documents and forget-me metadata. The process uses a JSON structure that includes summaries, topics, and sources of content to be excluded, enabling query-aware filtering. The iteration continues until achieving an acceptable forgetting score or reaching the per-query iteration limit.

One or more embodiments determine a new score for a generated response using an LM that evaluates the presence of excluded concepts (Operation 510). The LM analyzes the response against metadata of excluded concepts and evaluates forgetting metrics, including remaining excluded information and vector similarity to forbidden content. If the response fails to meet an acceptance threshold, the method 500 generates query variations in a feedback loop until achieving an acceptable score or reaching the maximum query iterations. This scoring ensures responses remain relevant while excluding specified concepts.

One or more embodiments include a decision point (Operation 512) that evaluates if a calculated score meets specified criteria within a feedback loop. An LM calculates the score to determine how effectively a response excludes forbidden concepts identified in metadata. When the score meets the criteria, the method 500 exits the feedback loop and transmits the response. Otherwise, the method 500 continues iterating by generating new query variations, retrieving information, and producing new responses until either achieving a satisfactory score or reaching a maximum iteration limit (Operation 514). This iterative process progressively improves responses to meet exclusion standards while maintaining quality.

One or more embodiments implement a feedback loop that monitors iteration counts when generating responses that exclude forbidden information. A per-query iteration limit check determines if processing has exceeded a maximum number of allowed iterations (N) for a single query, preventing endless loops (Operation 514). The method 500 iteratively generates query variations and responses until either achieving an acceptable response or reaching this limit. Upon reaching the limit without achieving acceptable forgetting, the method 500 stops processing and notifies the user. The per-query limit differs from the trial period threshold and specifically controls response refinement iterations through query variation, information retrieval, response generation, and score evaluation, helping maintain system efficiency.

### 2.5 Document Content Analysis

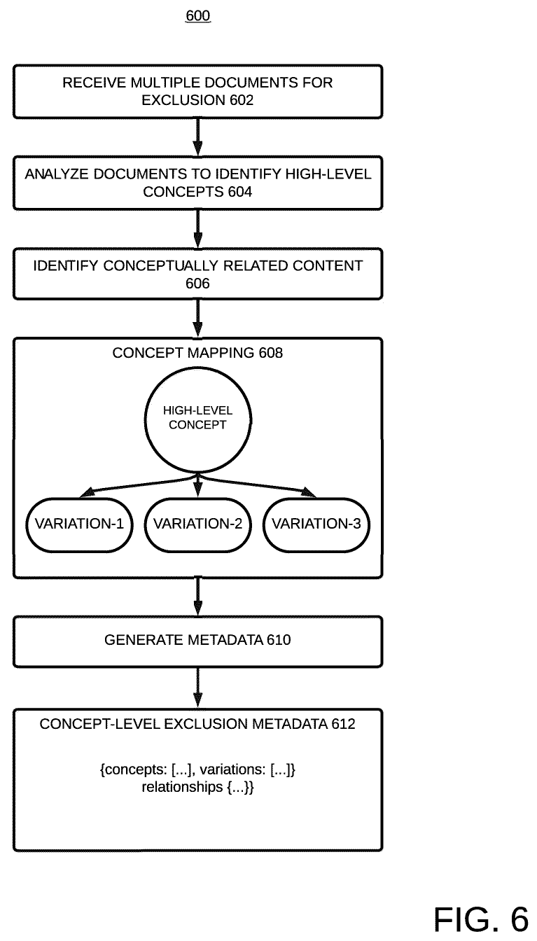

FIG. 6 illustrates a system 600 for identifying and characterizing high-level concepts across multiple documents and generating metadata for concept-level exclusion of related content according to one or more embodiments. The system 600 represents an extension of the method 100 of FIG. 1. Unless the context clearly indicates otherwise, the system 600 may be used in conjunction with or independent of any of other extensions of the method 100 of FIG. 1 disclosed herein with respect to the other figures.

One or more embodiments identify high-level concepts that appear across multiple documents in a set of documents that include information to be excluded from query responses. The system 600 determines conceptually related content that shares these high-level concepts even when the content uses different words or phrasings to express similar ideas. For example, different documents might describe the same technical concept using varying terminology or explanations. The system 600 generates metadata that characterizes both the identified high-level concepts and their conceptually related content variations. The metadata enables concept-level filtering that can recognize and exclude content based on its underlying meaning rather than just specific words or phrases. When analyzing a first response to exclude restricted content and generate a second response, the system 600 uses the metadata to identify and remove content that matches the characterized concepts at a semantic level even if the specific wording differs from the original excluded information. This approach ensures more comprehensive filtering by catching variations of excluded concepts rather than relying on exact text matching.

One or more embodiments receive (Operation 602) and analyze (Operation 604) multiple documents marked for exclusion to identify high-level conceptual relationships between them. The analysis processes chunks of content to generate topics, summaries, and metadata about content to be forgotten, focusing on conflicts, overlaps, and correlations between chunks. When processing documents that share common underlying concepts but different textual representations, one or more embodiments identify and characterize those shared concepts. The system 600 consolidates related chunks covering the same topic and resolves conflicts between chunks from different documents. The concept-level approach enables effective exclusion of information across different forms and variations with metadata characterizing the concepts and relationships to guide response generation.

One or more embodiments analyze documents marked for exclusion to identify high-level concepts shared across multiple documents regardless of their specific text or representations (Operation 604). The analysis examines document sets to identify common conceptual patterns and themes even when documents use different words or phrasings to express the same concepts.

One or more embodiments generate metadata capturing both the identified high-level concepts and their various textual representations across documents. The metadata enables concept-level exclusion during response generation, allowing the system 600 to recognize and exclude content matching conceptual patterns even when specific text differs from the original excluded documents. The concept-level approach enables more comprehensive exclusion of unwanted information compared to simple text matching, for the concept-level approach can identify and exclude variations of underlying concepts expressed differently across documents or responses.

One or more embodiments identify conceptually related content by analyzing high-level concepts shared across multiple documents even when expressed with different words or phrasings (Operation 606). The analysis goes beyond simple text matching to recognize when different content pieces share underlying concepts, enabling comprehensive exclusion of sensitive or outdated information. For example, when 100 pages share a common concept despite being otherwise unrelated, the system 600 identifies that specific concept rather than just matching exact text. The metadata generation captures both high-level concepts and their various expressions, creating a rich characterization that enables concept-level exclusion during response generation, helping prevent leakage of excluded information.

One or more embodiments implement concept mapping 608 to identify high-level concepts spanning multiple excluded documents even when expressed differently. The concept mapping 608 analyzes documents to find common themes and connects seemingly unrelated content. For example, when 100 pages share an underlying concept despite different specific text, the concept mapping identifies this shared conceptual thread. The concept mapping 608 enables exclusion at a conceptual level rather than just matching exact text. The concept mapping 608 determines conceptual relationships between content using different words or phrasings, generates metadata capturing both high-level concepts and their textual variations, and uses this metadata to filter out content related to forbidden concepts from responses.

One or more embodiments analyze excluded documents using a metadata generation process that identifies high-level concepts shared across multiple documents rather than just matching specific text (Operation 610). The metadata generation process identifies conceptual relationships between different content pieces even when they use different words or phrasing to express similar ideas. The generated metadata captures both the high-level concepts and their various manifestations across documents, enabling the recognition and exclusion of information based on meaning rather than exact text matching. This allows for comprehensive exclusion of forbidden information regardless of how ideas are expressed.

One or more embodiments implement concept-level exclusion metadata that identifies and tracks high-level concepts shared across multiple excluded documents, enabling exclusion of conceptually related content regardless of specific wording (Operation 612). The metadata generator analyzes documents to identify shared concepts, determines conceptually related content, and compiles this information into a data structure. A grader agent uses the concept-level exclusion metadata to verify conceptual-level forgetting in responses, providing more comprehensive exclusion than text-based matching alone.

### 2.6 Organization-Level Pattern Analysis

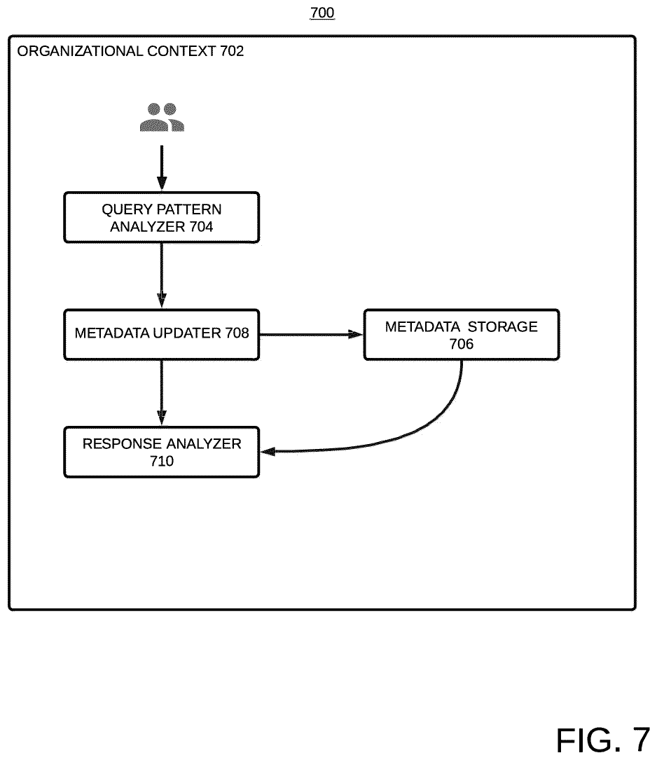

FIG. 7 illustrates a system 700 for analyzing query patterns across multiple organizational users and updating metadata to exclude sensitive information in subsequent query responses according to one or more embodiments. The system 700 represents an extension of the method 100 of FIG. 1. Unless the context clearly indicates otherwise, the system 700 may be used in conjunction with or independent of any of other extensions of the method 100 of FIG. 1 disclosed herein with respect to the other figures.

One or more embodiments maintain and utilize organizational context across multiple users within an organization to improve the identification and exclusion of sensitive information. The system 700 tracks patterns in queries submitted by multiple users within the organization. These patterns help identify common types of sensitive information that should be excluded from responses. Based on the identified patterns, the system 700 updates the metadata that characterizes concepts to be excluded. This updated metadata enhances the analysis of responses to future queries from any user within the organization.

For example, if multiple users frequently submit queries about similar topics and certain information in the responses consistently needs to be excluded, the system 700 recognizes these patterns. The system 700 then updates the system 700's metadata to better characterize these commonly occurring sensitive concepts. When analyzing future responses to queries from any organizational user, the system 700 applies this enhanced metadata. This allows for more accurate and consistent exclusion of sensitive information across users within the organization.

This organizational-level pattern analysis builds upon the base method 100 of FIG. 1 of excluding sensitive information from individual responses. The system 700 still obtains documents with information to be excluded, analyzes the documents for concepts, generates metadata, and uses that metadata to filter responses. However, the system 700 now additionally learns from patterns across multiple users to continuously improve the system 700's ability to identify and exclude sensitive information in a way that reflects the organization's specific security needs.

One or more embodiments include an organizational context component 702 that maintains context information across multiple organizational users. The organizational context component 702 tracks query patterns from different users, identifies common patterns in sensitive information across queries, and updates metadata for excluded concepts accordingly. This enables consistent handling of sensitive information exclusion across organizational users rather than handling queries individually. The organizational context component 702 applies updated metadata when filtering responses to new queries, helping maintain uniform exclusion standards while improving sensitive content recognition.

One or more embodiments implement a query pattern analyzer component 704 that processes query patterns across multiple users within an organization. The analyzer examines organizational queries to identify common patterns involving sensitive information requiring exclusion. Upon detecting recurring patterns, the query pattern analyzer updates metadata guiding content exclusion. When queries from multiple users reveal sensitive topics, the analyzer updates metadata to exclude that information from future organizational queries. This organization-wide analysis approach provides more robust protection of sensitive information compared to processing individual queries in isolation.

One or more embodiments implement a metadata storage component 706 that stores and updates metadata for excluding sensitive information organization-wide. The metadata storage component stores metadata about excluded concepts from documents while tracking multi-user query patterns within an organization. The metadata storage component builds organizational context by aggregating query patterns across users, continuously updates metadata based on new patterns, and applies consolidated metadata to filter responses for organizational users. This enables consistent handling of sensitive information and implements organization-level query-driven forgetting that evolves based on usage patterns.

One or more embodiments include a metadata updater component 708 that maintains metadata for excluding information across an organization by analyzing query patterns from multiple users, identifying common patterns and relationships, and updating metadata to reflect organization-wide patterns. The metadata updater component applies the updated metadata consistently to analyze and filter responses for users'subsequent queries, adapting exclusion criteria based on collective query behavior while maintaining a unified exclusion strategy.

One or more embodiments implement a response analyzer component 710 that maintains organizational-level context for managing information exclusion across multiple users. The analyzer processes query patterns to identify common themes requiring consistent handling of sensitive information, analyzes responses, and updates metadata based on organizational query history. The response analyzer component applies this refined metadata to filter responses for users, ensuring consistent exclusion of sensitive information organization-wide rather than per-user. The component maintains organizational context for query-driven forgetting, determining content exclusion based on both query context and organization-wide patterns.

### 2.7 Update and Exclusion Handling

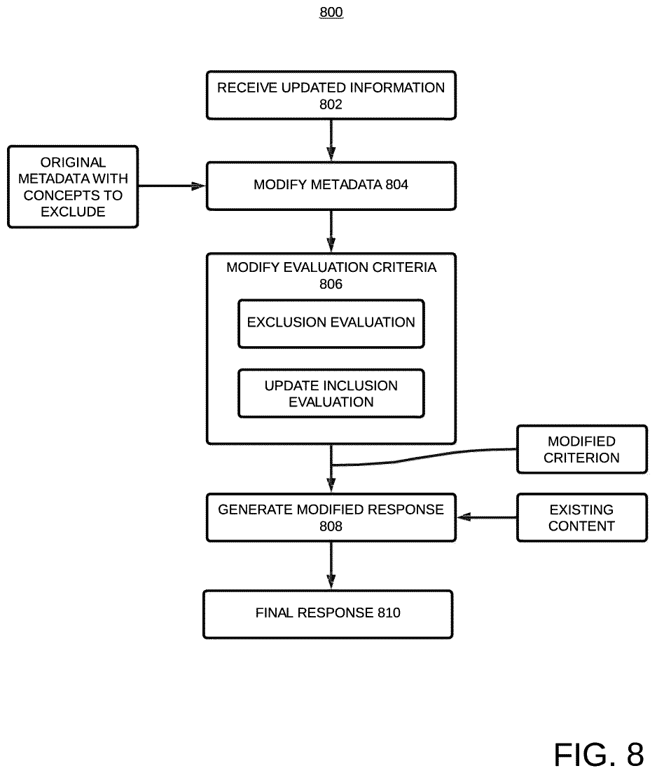

FIG. 8 illustrates a system 800 for modifying response generation by simultaneously incorporating update information and excluding specified concepts while maintaining content consistency according to one or more embodiments. The system 800 represents an extension of the method 100 of FIG. 1. Unless the context clearly indicates otherwise, the system 800 may be used in conjunction with or independent of any of other extensions of the method 100 of FIG. 1 disclosed herein with respect to the other figures.

One or more embodiments receive update information that should be incorporated into responses generated by a response generation system. The response generation system modifies metadata to specify both concepts that should be excluded from responses and update information that should be included in responses. The response generation system also modifies evaluation criteria to check for both proper exclusion of specified concepts and proper inclusion of the update information. When generating a modified response that excludes certain content from an initial response, the response generation system incorporates the update information while maintaining consistency with existing content and continuing to exclude the identified content. This allows the response generation system to simultaneously handle both exclusion of unwanted concepts and inclusion of new information while ensuring the generated responses remain coherent and consistent. The update process builds on the base method 100 of FIG. 1 of analyzing documents to identify concepts to exclude, generating metadata about those concepts, obtaining and analyzing initial responses, and generating modified responses that exclude specified content based on scoring criteria. The modified metadata and evaluation criteria enable the response generation system to maintain proper handling of exclusions while incorporating new required content.

One or more embodiments receive update information that includes information for incorporation into future responses while maintaining content exclusion capabilities (Operation 802). Users can provide new documentation, corrections, or knowledge through this input mechanism. The system 800 stores updates on a file server for automatic processing and modifies metadata to track both excludable concepts and new includable information. This enables simultaneous handling of forgetting and updating operations while maintaining response accuracy and content restrictions.

One or more embodiments include a modify metadata component 804 that maintains a dual-purpose data structure for managing both excluded concepts and new update information in response generations. The modify metadata component 804 processes incoming updates and integrates them with existing metadata while preserving context and relationships between excluded and included content. When receiving updates, the modify metadata component 804 analyzes and modifies the metadata structure to incorporate both exclusion rules and inclusion requirements, enabling simultaneous content filtering and information incorporation while maintaining consistency with grading criteria.

One or more embodiments include a criterion modification component 806 that modifies scoring criteria to handle both forgetting and updating of information. The criterion modification component 806 adjusts evaluation parameters to verify responses excluding unwanted concepts while incorporating new update information. The criterion modification component 806 processes modified metadata that includes both exclusion specifications and update requirements. When evaluating responses, the criterion modification component 806 applies criteria to maintain consistency between valid content and new information while excluding forbidden concepts, allowing a single architecture to handle both selective forgetting and knowledge updating.

One or more embodiments implement a response generation component 808 that generates updated responses while maintaining content exclusion requirements. The response generation component 808 receives update information and metadata specifying both concepts to exclude and new information to include. The response generation component 808 incorporates updates while ensuring continued exclusion of forbidden content through specialized prompting and filtering mechanisms.

The response generation component 808 maintains consistency between new updates and valid existing content by analyzing potential conflicts between updates and excluded content. The response generation component 808 preserves response coherence and logical structure while integrating new information. The response generation block 808 uses modified evaluation criteria to verify both proper inclusion of updates and exclusion of forbidden content.

This approach enables knowledge base evolution through updates while maintaining compliance with content exclusion requirements.

One or more embodiments process a final response 810 that incorporates update information while excluding forbidden content through modified metadata tracking. The metadata tracks both excluded concepts and new information to include. The system 800 evaluates the final response 810 against criteria that verify both proper exclusion of forbidden concepts and inclusion of updates, transmitting the final response 810 when the final response 810 meets these requirements.

### 2.8 Mutti-Stage Process for Generating Metadata

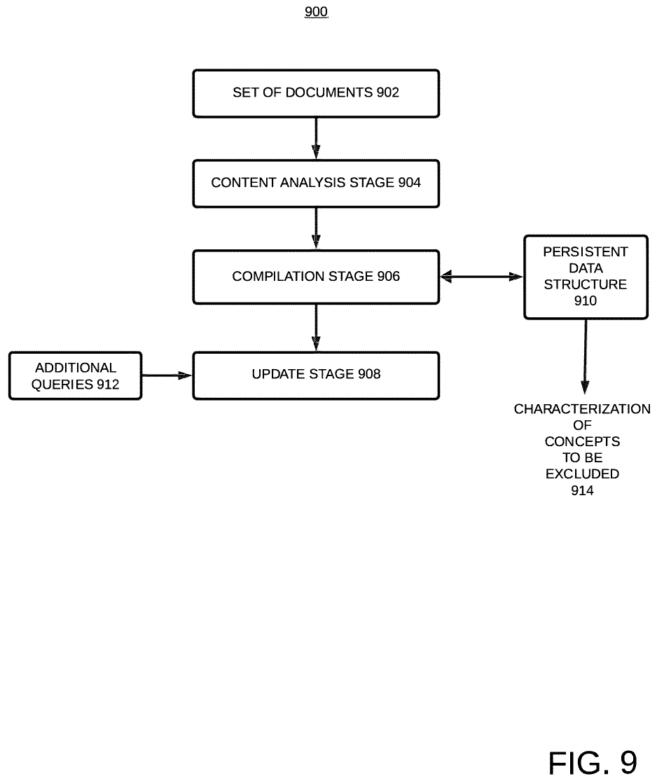

FIG. 9 illustrates a system 900 for processing documents through multiple stages to generate metadata characterizing excluded concepts and maintaining them in a persistent data structure according to one or more embodiments. The system 900 represents an extension of the method 100 of FIG. 1. Unless the context clearly indicates otherwise, the system 900 may be used in conjunction with or independent of any of other extensions of the method 100 of FIG. 1 disclosed herein with respect to the other figures.

One or more embodiments generate metadata through a multi-stage document processing approach. The system 900 first analyzes portions of content from documents, including information to be excluded. This analysis creates topics and summaries that characterize the excluded information. The system 900 then compiles these topics and summaries into a persistent data structure. The persistent data structure maintains information about concepts to be excluded and persists across multiple query processing operations. As the system 900 processes additional queries, the system 900 updates the persistent data structure to refine and expand the characterization of excluded concepts.

This metadata generation process supports the broader method 100 of FIG. 1 of filtering responses. The system 900 uses the generated metadata to analyze responses produced by a response generation system. When analyzing a first response to a query, the system 900 identifies content that matches the characterized concepts in the metadata. The system 900 then generates a second response that excludes the identified content. The system 900 evaluates this second response using an LM to determine a score based on the presence of excluded concepts. If the score meets specified criteria, the system 900 transmits the second response to the query.

The persistent data structure enables dynamic and evolving concept exclusion. As the system 900 processes more queries, the system 900 continuously updates the system 900's understanding of concepts to be excluded. This adaptive approach improves the system 900's ability to identify and filter out unwanted content across multiple query responses.

One or more embodiments process documents 902 through a metadata generation pipeline to identify information for exclusion from query responses. The pipeline analyzes document portions and generates topics and summaries characterizing key concepts to exclude. A compiler agent compiles these topics and summaries into a persistent data structure that maintains a record of concepts to exclude across queries. The system 900 updates the persistent data structure as the system 900 processes additional queries, refining the characterization of excluded concepts without requiring direct deletion from knowledge bases or models.

One or more embodiments implement a content analysis stage 904 that processes exclusion-marked documents through sequential stages to generate metadata about concepts to exclude from system responses. The content analysis stage 904 analyzes extracted content to identify key topics and create summaries characterizing excluded information. The content analysis stage 904 compiles these topics and summaries into a persistent data structure that maintains exclusion information across multiple queries. As the system 900 processes new queries, the content analysis stage 904 updates the data structure with newly discovered patterns and relationships between excluded content chunks. The content analysis stage 904 specifically focuses on analyzing conflicts, overlaps, and key topics within excluded content.

One or more embodiments implement a compilation stage 906 that processes documents marked for exclusion to create and maintain a persistent data structure characterizing concepts to exclude from responses. The system 900 analyzes document content to generate topics and summaries, compiling the topics and summaries into the data structure that serves as a reference for filtering multiple queries. The system 900 continuously updates the data structure through a compiler agent that works with metadata to track complex document correlations and dependencies, enabling increasingly accurate characterization of excluded concepts over time. The compiler agent creates either an in-memory or distributed data structure that maintains exclusion information beyond individual queries.

One or more embodiments implement an update stage 908 that continuously refines information about concepts to exclude from system responses. The update stage 908 updates a persistent data structure by analyzing how new queries interact with previously identified topics and summaries. The update stage 908 examines query patterns and responses to identify new relationships and variations of excluded concepts, incorporating these insights to maintain the data structure's currency. This continuous refinement process helps adapt to new query patterns and ensures comprehensive characterization of excluded concepts across diverse contexts.

One or more embodiments use a persistent data structure 910 to store compiled metadata about concepts excluded from query responses. The data structure maintains digest information characterizing excluded content, including topics and summaries from analyzed excluded document portions. The data structure persists across queries to maintain consistent exclusion rules and updates continuously as new queries are processed. When processing related queries, the system 900 consolidates exclusion instructions at a conceptual level. The persistent data structure may be implemented in-memory or distributed, storing forget-me digest information in a query-aware format, such as JSON, with fields for summaries, topics, sources, and other exclusion metadata. The persistent data structure enables efficient filtering of forbidden content while maintaining performance across queries.

One or more embodiments process multiple additional queries 912 through stages to build and refine metadata about concepts for exclusion from responses. The system 900 analyzes excluded content across queries to create topics and summaries, compiling the topics and summaries into a persistent data structure. As new queries are processed, the system 900 continuously updates the persistent data structure to better characterize excluded concepts, enabling robust identification and exclusion of unwanted information.

One or more embodiments characterize concepts for exclusion 914 through multi-stage document processing. The process analyzes excluded content to identify key topics and generate summaries using a metadata generator that chunks content and identifies core concepts for exclusion.

One or more embodiments store the identified topics and summaries in a persistent data structure, acting as a repository for excluded concepts across queries. The data structure uses a query-aware JSON format that includes fields for summaries, topics, sources, and related metadata.

One or more embodiments continuously update the data structure while processing queries, refining the characterization of excluded concepts by consolidating information, resolving conflicts, and maintaining context.

One or more embodiments focus on identifying concepts to be forgotten rather than matching specific text, enabling removal of related content across different formats and variations in the knowledge base. This allows concept-level exclusion by identifying shared concepts across otherwise unrelated documents.

### 2.9 Integrated Response Generation and Verification Process

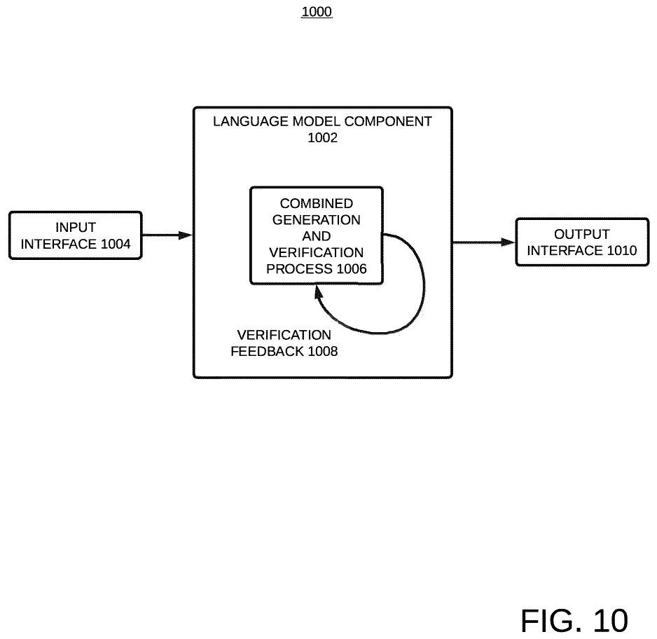

FIG. 10 illustrates a system 1000 for generating responses using an LM that simultaneously performs concept verification and response generation in an integrated process according to one or more embodiments. The system 1000 represents an extension of the method 100 of FIG. 1. Unless the context clearly indicates otherwise, the system 1000 may be used in conjunction with or independent of any of other extensions of the method 100 of FIG. 1 disclosed herein with respect to the other figures.

One or more embodiments utilize an LM to perform both the generation of the filtered response and the verification of concept exclusion in a single integrated process. The LM actively generates the second response while simultaneously evaluating if any concepts marked for exclusion in the metadata are present. This concurrent generation and evaluation approach differs from a two-step process where generation and verification would occur separately. The LM checks for the presence of excluded concepts during the response generation process itself, incorporating this verification directly into the generation workflow. By combining these steps, the LM ensures compliance with exclusion requirements as part of the natural response formation rather than requiring a separate post-generation evaluation step. This integrated approach allows the LM to dynamically adjust the response content during generation to avoid including any concepts that match the exclusion metadata.

One or more embodiments employ an LM component 1002 that combines generation and evaluation into a unified process. The LM component generates responses while monitoring for excluded concepts based on metadata. The LM component performs real-time verification during generation, references metadata about excluded concepts, and maintains awareness of forbidden concepts to immediately adjust responses. This integrated approach improves efficiency by eliminating separate generation and evaluation steps while ensuring compliance with exclusion requirements.

One or more embodiments include an input interface 1004 that receives input for an LM, combining response generation and concept exclusion verification in a unified process. The input interface provides both the query and metadata about concepts to exclude, enabling the LM to actively avoid forbidden concepts during response generation rather than requiring separate post-generation evaluation. This allows real-time verification while generating responses, filtering out forbidden information during the generation process itself.

One or more embodiments implement a combined generation and verification process 1006 that integrates response generation with concept exclusion verification. An LM actively monitors and excludes forbidden concepts during response generation rather than verifying after completion. The LM references metadata about concepts to be excluded while generating each portion of the response, evaluating in real-time if any forbidden concepts are present. This integrated approach maintains response coherence, reduces computational overhead, and preserves natural flow by making exclusion decisions in context.

One or more embodiments implement verification feedback 1008 that enables real-time verification of concept exclusion during response generation. The feedback allows simultaneous response generation and verification of excluded concepts, integrating these as a unified process. The LM monitors concepts in the metadata while generating the response and immediately adjusts the language model's output if excluded concepts are detected, avoiding the need for separate post-generation verification.

One or more embodiments provide an output interface 1010 that transmits responses after an LM generates and verifies them. The interface delivers responses while ensuring the exclusion of specified concepts during generation. The output interface transmits responses after confirming that concepts marked for exclusion in metadata are absent. The interface combines response generation and verification in a unified workflow, eliminating the need for separate post-generation evaluation and improving efficiency.

### 3. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

In the example, a cloud service provider maintains a large corpus of online support documentation for their services. Over time, as services evolve and features change, certain support documents become deprecated. However, these documents remain indexed in the knowledge base and continue to influence responses to customer queries.

The cloud provider identifies a set of deprecated support documents that should no longer influence responses to customer queries. These documents are provided as input to the system. The system analyzes the deprecated documents to identify various key concepts, such as outdated feature names, deprecated API calls, obsolete configuration settings, and discontinued service tiers.

One or more embodiments generate metadata characterizing these concepts. For example, the metadata might indicate that “StorageV1 API” is deprecated in favor of “StorageV2 API” or that the “basic-tier” service level no longer exists. This metadata includes context about why these concepts are deprecated and what current alternatives exist.

When a customer submits a query like, “How do I configure storage retention policies?”, one or more embodiments initially generate a response that might include references to both current and deprecated storage APIs. One or more embodiments analyze this initial response against the metadata and identifies content mentioning deprecated concepts like the StorageV1 API.

One or more embodiments then generate a new response that excludes the deprecated content, focusing on current features and APIs. An LM evaluates this new response to ensure it does not include references to deprecated concepts while still providing helpful information about storage retention policies. One or more embodiments calculate a score based on how successfully the response excludes deprecated information while maintaining accuracy and usefulness.

If the score meets the required threshold, indicating that the response successfully excludes deprecated information while remaining helpful, one or more embodiments transmit the response to the customer. This ensures customers receive current, accurate information about the cloud provider's services.

Through this process, the cloud provider effectively “forgets” deprecated documentation without requiring manual updates to its entire knowledge base or disrupting its response generation system. The approach handles complex cases where deprecated features might be mentioned in various contexts across many documents, ensuring consistent exclusion of outdated information from responses.

### 4. Practical Applications, Advantages, and Improvements

One or more embodiments enable organizations to maintain current and accurate information delivery without rebuilding or retraining their response generation systems. For example, financial institutions can exclude outdated regulatory guidance, healthcare providers can exclude superseded medical protocols, and technology companies can exclude deprecated product documentation, all while their existing systems continue to operate.

One or more embodiments provide significant practical advantages in resource conservation. By selectively excluding information through metadata and response analysis rather than system rebuilding, organizations conserve computational resources and reduce operational costs. This approach eliminates the need for resource-intensive reindexing of knowledge bases or retraining of models.

One or more embodiments provide significant practical advantages in operational continuity. Organizations maintain continuous operation of their response generation systems while implementing information exclusion. This eliminates system downtime and preserves service availability during the process of excluding unwanted information.

One or more embodiments provide significant practical advantages in information governance. Organizations gain fine-grained control over information exclusion at a conceptual level. This enables systematic management of outdated, incorrect, or inappropriate information across large-scale knowledge bases without manual intervention in each document.

One or more embodiments provide significant practical advantages in quality assurance. Through LM evaluation and scoring mechanisms, organizations ensure responses consistently exclude unwanted information while maintaining relevance and accuracy. This automated quality control reduces the risk of distributing outdated or incorrect information.

One or more embodiments provide a technical improvement in conceptual exclusion. By operating at the concept level rather than the text level, organizations can exclude information more effectively than traditional keyword-based approaches. This handles cases where the same concept appears in different forms across multiple documents.

One or more embodiments provide a technical improvement in conceptual system independence. Organizations can implement information exclusion without modifying their underlying response generation systems. This provides flexibility in environments where direct system modification is impractical or prohibited.

One or more embodiments provide a technical improvement in scalable processing. Through metadata-based analysis and automated scoring, organizations can process large volumes of responses efficiently. This scales to handle enterprise-level information management needs while maintaining consistent quality.

One or more embodiments provide a technical improvement in verifiable results. Organizations obtain measurable confirmation that responses exclude unwanted information through scoring mechanisms. This provides accountability and confidence in the information exclusion process.

These practical applications, advantages, and improvements enable organizations to maintain accurate and current information delivery while preserving system stability and operational efficiency.

### 5. Example Language Model Architecture

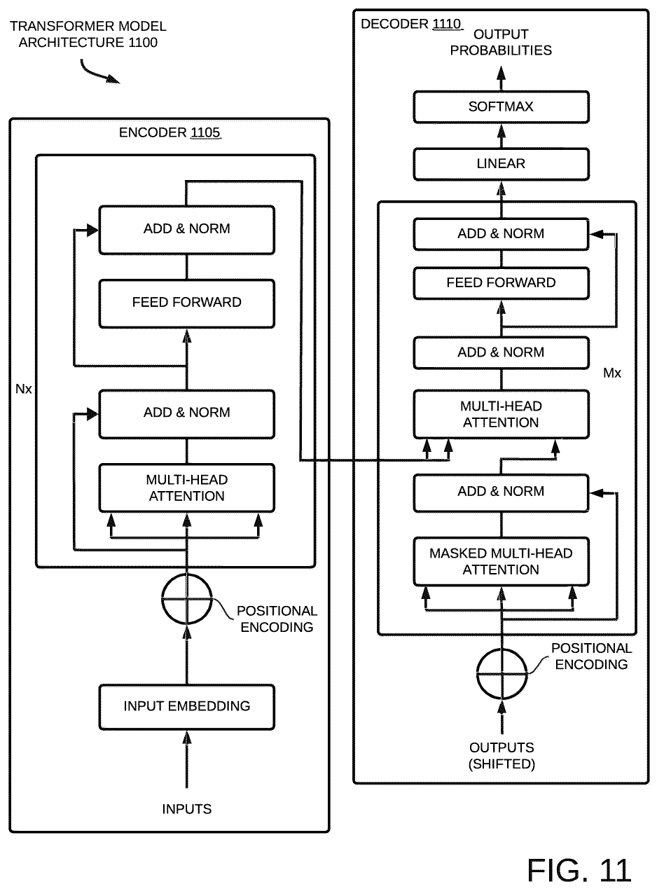

FIG. 11 illustrates an example transformer model architecture 1100 that is used in the implementation of an LM according to one or embodiments of the present disclosure.

The transformer model architecture 1100 is a neural network design for natural language processing. The architecture 1100 encompasses an encoder 1105 and a decoder 1110, both leveraging self-attention mechanisms. The architecture 1100 begins with an input embedding layer that converts tokens into high-dimensional vector representations that range, for example, from 128 to 1024 dimensions. These embeddings are augmented with positional encodings to retain sequence order information.

The transformer model architecture 1100's input embedding layer serves as the initial processing stage for converting discrete tokens into continuous vector representations. These dense embeddings occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings are implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The architecture 1100 includes a multi-head, self-attention mechanism. This allows the architecture 1100 to simultaneously attend to different parts of the input sequence, capturing various types of relationships and dependencies. An attention head computes query, key, and value vectors, enabling the model to focus on relevant parts of the input when processing a token. Following the attention layers, the architecture 1100 incorporates feed-forward neural networks with multiple layers and non-linear activation functions.

The multi-head self-attention mechanism forms a component of the transformer architecture 1100, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked multi-head attention mechanism in the decoder 1110 of a transformer architecture 1100 is designed to prevent the model from attending to future tokens during sequence generation. In this mechanism, multiple attention heads operate in parallel, a computing query (Q), key (K), and value (V) matrices from the input embeddings. The attention scores are calculated as the dot product of Q and K, scaled by the inverse square root of the dimension of the keys. A lower triangular mask is applied to these attention scores before softmax normalization, effectively setting the upper triangular elements to negative infinity. This masking ensures that a position can attend to previous positions in the sequence, maintaining the autoregressive property of the decoder. The masked attention scores are then used to compute a weighted sum of the value vectors. The outputs from the heads are concatenated and linearly transformed to produce the attention output. This process allows the decoder to generate tokens sequentially while considering the previously generated tokens, thus preserving the causal nature of language modeling.

The masked multi-head attention mechanism in the transformer's decoder 1110 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the architecture 1100 employs layer normalization after a sub-layer (self-attention and feed-forward networks) and introduces residual connections. These residual connections allow unimpeded information flow through the network. The model includes multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer involves a linear transformation followed by a softmax function, producing probability distributions over the vocabulary for text generation tasks. This architecture 1100's design allows for efficient parallel processing of input sequences, making it particularly suitable for handling the extensive datasets used in training language models.

The output layer of the transformer architecture implements a vocabulary-sized classification mechanism through a linear transformation followed by softmax activation. The linear transformation projects the decoder's hidden states onto a vocabulary-sized space using a weight matrix W ε [symbol] \hat{ }(d_model×|V|), where d_model represents the model's hidden dimension and |V| represents the vocabulary size. The subsequent softmax function normalizes these logits into a proper probability distribution across the entire vocabulary, computing P(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O(1) sequential operations compared to the O(n) operations needed in recurrent architectures. The model's parallelization efficiency scales particularly well with increasing sequence lengths, making the architecture advantageous for processing the extensive datasets used in large language model training, that often include billions of tokens across diverse domains and languages.

In one or more embodiments, architectural variations enhance or modify the standard transformer design for language model implementations. The sparse transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The performer architecture replaces the attention mechanism with kernel-based formulations using random feature decomposition, achieving linear complexity in both compute and memory.

Alternate positional encoding schemes offer various trade-offs. Rotary Positional Embeddings (RoPE) inject positional information through rotation matrices applied to token embeddings, providing better relative position modeling. ALiBi (Attention with Linear Biases) position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash attention optimizes attention computation through careful management of GPU memory access patterns. Mixture of Experts (MoE) architectures incorporate sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. The “DeepNorm” normalization strategy modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for language model implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures capture complex dependencies that are difficult to model with purely sequential approaches, though these architectures require careful design of graph structure and update rules.

In one or more embodiments, the transformer-based language model architecture 1100 is not deployed in isolation but rather serves as a module within an overall reasoning framework. In these systems, the language model is integrated into a multi-stage reasoning pipeline that combines the raw generative capabilities of the transformer with additional processes aimed at structured, step-by-step reasoning.

In such a reasoning framework, the language model may be tasked with generating intermediate representations or “chain-of-thought” outputs. These outputs detail intermediate reasoning steps that help decompose complex queries into manageable sub-tasks. For example, the language model may generate an initial hypothesis or a series of candidate reasoning steps, which are then validated by auxiliary modules responsible for consistency checks, fact verification, or domain-specific reasoning rules. This design enables the system to not only generate fluent natural language responses but also to provide transparency into the reasoning process underlying each response.

Moreover, reasoning architectures may incorporate a controller or supervisory module that orchestrates interactions between the language model and other specialized reasoning components. This controller can guide the selection of reasoning paths, manage iterative refinement (e.g., revising or expanding upon earlier generated steps), and leverage external knowledge bases or memory stores to enhance the overall reasoning performance. In one or more embodiments, additional layers of analysis—such as external search mechanisms or multi-hop reasoning strategies—further empower the system to tackle more complex, context-dependent tasks while ensuring that the output remains coherent and logically sound.

By embedding the language model within a larger reasoning ecosystem, one or more embodiments overcome some of the limitations inherent in standalone transformer architectures, such as the lack of explicit intermediate reasoning steps. The integration fosters a symbiotic relationship where the language model's strength in pattern recognition and language generation complements dedicated reasoning and verification processes. As a result, the overall system is capable of improved decision-making, enhanced problem solving, and more robust handling of tasks that require deep and structured reasoning.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

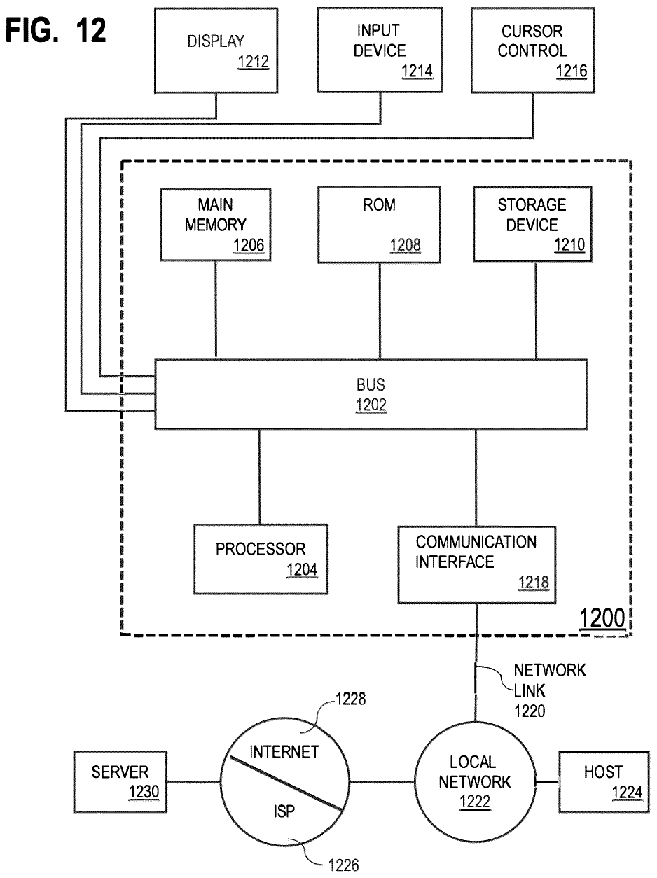

FIG. 12 is a block diagram that illustrates an example computer system 1200 upon which one or more embodiments are implemented. Computer system 1200 includes a bus 1202 or other communication mechanism for communicating information, and a hardware processor 1204 coupled with bus 1202 for processing information. Hardware processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or a Solid-State Drive (SSD) is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic that in combination with the computer system causes or programs computer system 1200 to be a special-purpose machine. According to one embodiment, the techniques herein are performed by computer system 1200 based on processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from that processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, that carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### 8. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

What is claimed is:

1. A method comprising:
obtaining a set of documents comprising information to be excluded from responses generated by a response generation system that generates responses to queries;
analyzing the information to be excluded to identify concepts present in the information to be excluded;
generating metadata that characterizes the concepts to be excluded;
obtaining a first response to a query, wherein the first response is generated by the response generation system;
analyzing the first response, based on at least in the metadata, to identify content of the first response to be excluded to generate a second response to the query;
generating the second response to the query, wherein the second response excludes the identified content of the first response to be excluded;
determining a score for the second response based on at least a language model evaluating the second response for presence of one or more of the concepts characterized by the metadata; and
transmitting the second response to the query based on at least determining that the score meets a criterion.

2. The method of claim 1, further comprising:
maintaining context information across multiple queries, wherein the query is one of the multiple queries;
identifying patterns among the multiple queries; and
consolidating the metadata that characterizes the concepts to be excluded based on the identified patterns.

3. The method of claim 1, wherein analyzing the information to be excluded comprises:
identifying correlations between documents of the set of documents and documents in a knowledge base;
generating the metadata to distinguish target information to be excluded from related valid content; and
using the metadata to selectively exclude the target information while preserving the related valid content during generation of the second response.

4. The method of claim 1, further comprising:
generating multiple variations of the query while maintaining conceptual similarity to the query;
routing the multiple variations to different portions of a knowledge base;
retrieving information relevant to each variation of the multiple variations; and
combining the retrieved information prior to obtaining the first response.

5. The method of claim 1, further comprising:
when the score does not meet the criterion:
initiating a loop comprising:
generating a variation of the query,
retrieving information relevant to the variation of the query,
generating a new response using the retrieved information, and
determining a new score for the new response based on at least the language model evaluating the new response for presence of one or more of the concepts characterized by the metadata; and
continuing the loop until either:
the new score meets the criterion, or
a per-query iteration limit is reached.

6. The method of claim 1, wherein analyzing the information to be excluded comprises:
identifying high-level concepts that are common across multiple documents of the set of documents;
determining conceptually related content that shares the identified high-level concepts while having different textual representations; and
wherein generating the metadata comprises characterizing both the high-level concepts and the conceptually related content to enable concept-level exclusion from the first response and the second response.

7. The method of claim 1, further comprising:
maintaining an organizational context for multiple users within an organization;
identifying patterns across multiple queries from the multiple users, wherein the query is one of the multiple queries;
updating the metadata based on the identified patterns for exclusion of sensitive information across the multiple users within the organization; and
applying the updated metadata to analyze responses to subsequent queries received from the multiple users within the organization.

8. The method of claim 1, further comprising:
receiving update information to be incorporated into responses generated by the response generation system;
modifying the metadata to specify both the concepts to be excluded and update information to be included;
modifying the criterion to evaluate both proper exclusion of the concepts characterized by the metadata and proper inclusion of the update information; and
wherein generating the second response comprises incorporating the update information while maintaining consistency with existing content and continuing to exclude the identified content of the first response to be excluded.

9. The method of claim 1, wherein generating the metadata comprises:
processing the set of documents through multiple stages including:
analyzing portions of content from the set of documents to create topics and summaries characterizing the information to be excluded;
compiling the topics and summaries into a persistent data structure that maintains information about the concepts to be excluded across multiple queries, wherein the query is one of the multiple queries; and
updating the persistent data structure as additional queries of the multiple queries are processed to provide characterization of the concepts to be excluded.

10. The method of claim 1, wherein generating the second response and determining the score are performed by the language model, and wherein the language model:
generates the second response while evaluating if the concepts characterized by the metadata are present in the second response; and
verifies exclusion of the concepts during the generation of the second response rather than as a separate evaluation step.

11. One or more non-transitory computer-readable media storing a set of instructions which, when executed by a set of one or more processors, cause a set of one or more computer systems to perform a set of operations comprising:
obtaining a set of documents comprising information to be excluded from responses generated by a response generation system that generates responses to queries;
analyzing the information to be excluded to identify concepts present in the information to be excluded;
wherein analyzing the information to be excluded comprises:
identifying high-level concepts that are common across multiple documents of the set of documents, and
determining conceptually related content that shares the identified high-level concepts while having different textual representations;
generating metadata that characterizes the concepts to be excluded, wherein generating the metadata comprises characterizing both the high-level concepts and the conceptually related content to enable concept-level exclusion from responses generated by the response generation system;
obtaining a first response to a query, wherein the first response is generated by the response generation system;
analyzing the first response, based on at least in the metadata, to identify content of the first response to be excluded to generate a second response to the query;
generating the second response to the query, wherein the second response excludes the identified content of the first response to be excluded;
determining a score for the second response based on at least a language model evaluating the second response for presence of one or more of the concepts characterized by the metadata; and
transmitting the second response to the query based on at least determining that the score meets a criterion.

12. The one or more non-transitory computer-readable media of claim 11, the set of operations further comprising:
maintaining context information across multiple queries, wherein the query is one of the multiple queries;
identifying patterns among the multiple queries; and
consolidating the metadata that characterizes the concepts to be excluded based on the identified patterns.

13. The one or more non-transitory computer-readable media of claim 11, the set of operations further comprising:
identifying correlations between documents of the set of documents and documents in a knowledge base;
generating the metadata to distinguish target information to be excluded from related valid content; and
using the metadata to selectively exclude the target information while preserving the related valid content during generation of the second response.

14. The one or more non-transitory computer-readable media of claim 11, the set of operations further comprising:
generating multiple variations of the query while maintaining conceptual similarity to the query;
routing the multiple variations to different portions of a knowledge base;
retrieving information relevant to each variation of the multiple variations; and
combining the retrieved information prior to obtaining the first response.

15. The one or more non-transitory computer-readable media of claim 11, the set of operations further comprising:
when the score does not meet the criterion:
initiating a loop comprising:
generating a variation of the query,
retrieving information relevant to the variation of the query,
generating a new response using the retrieved information, and
determining a new score for the new response based on at least the language model evaluating the new response for presence of one or more of the concepts characterized by the metadata; and
continuing the loop until either:
the new score meets the criterion, or
a per-query iteration limit is reached.

16. A system comprising:
one or more computer systems having a set of one or more hardware processors, and
instructions which, when executed, cause the one or more computer systems to perform a set of operations comprising:
obtaining a set of documents comprising information to be excluded from responses generated by a response generation system that generates responses to queries;
analyzing the information to be excluded to identify concepts present in the information to be excluded;
wherein analyzing the information to be excluded comprises:
identifying high-level concepts that are common across multiple documents of the set of documents, and
determining conceptually related content that shares the identified high-level concepts while having different textual representations;
generating metadata that characterizes the concepts to be excluded, wherein generating the metadata comprises characterizing both the high-level concepts and the conceptually related content to enable concept-level exclusion from responses generated by the response generation system;
obtaining a first response to a query, wherein the first response is generated by the response generation system;
analyzing the first response, based on at least in the metadata, to identify content of the first response to be excluded to generate a second response to the query;
generating the second response to the query, wherein the second response excludes the identified content of the first response to be excluded;
determining a score for the second response based on at least a language model evaluating the second response for presence of one or more of the concepts characterized by the metadata; and
transmitting the second response to the query based on at least determining that the score meets a criterion.

17. The system of claim 16, the set of operations further comprising:
maintaining context information across multiple queries, wherein the query is one of the multiple queries;
identifying patterns among the multiple queries; and
consolidating the metadata that characterizes the concepts to be excluded based on the identified patterns.

18. The system of claim 16, the set of operations further comprising:
identifying correlations between documents of the set of documents and documents in a knowledge base;
generating the metadata to distinguish target information to be excluded from related valid content; and
using the metadata to selectively exclude the target information while preserving the related valid content during generation of the second response.

19. The system of claim 16, the set of operations further comprising:
generating multiple variations of the query while maintaining conceptual similarity to the query;
routing the multiple variations to different portions of a knowledge base;
retrieving information relevant to each variation of the multiple variations; and
combining the retrieved information prior to obtaining the first response.

20. The system of claim 16, the set of operations further comprising:
when the score does not meet the criterion:
initiating a loop comprising:
generating a variation of the query,
retrieving information relevant to the variation of the query,
generating a new response using the retrieved information, and
determining a new score for the new response based on at least the language model evaluating the new response for presence of one or more of the concepts characterized by the metadata; and
continuing the loop until either:
the new score meets the criterion, or
a per-query iteration limit is reached.
